(19) United States
(12) Patent Application Publication
(10) Pub. No.: US 2002/0098329 A1
(43) Pub. Date: Jul. 25, 2002

(54) Enhanced resolution multicolored flock transfer

(76) Inventor: L. Brown Abrams, Fort Collins, CO (US)

Correspondence Address: Sheridan Ross P. C., Suite 1200, 1560 Broadway, Denver, CO, 80202-5141, US

(21) Appl. No.: 09/973,113

(22) Filed: Oct. 9, 2001

Related U.S. Application Data
(60) Provisional application No. 60/238,778, filed on Oct. 10, 2000.

(51) Int. Cl. B41M 3/12; B32B 27/14

(52) U.S. Cl. 428/204; 427/147; 428/195

(57) ABSTRACT

An enhanced resolution multicolored flock transfer comprises a release sheet having a surface coated with a release adhesive, flock having individual 0.75 millimeter 1.5 denier fibers, a design printed on the flock by use of a four color process by using side by side color separations, and a binding adhesive applied to the flock.

### BACKGROUND OF THE INVENTION

This invention relates to a method of manufacturing flock transfers, and more particularly to a multicolored flock transfer having enhanced resolution.

Flock transfers are used to enhance the appearance of a garment, such as T-shirts or jeans, and other materials, such as wallpaper or carpets. Typically, there are two basic methods used in applying a multicolored flock design to a surface. The first method is known as direct flocking. In this method, the flock is applied directly to the surface that forms the finished product. One known method of direct flocking includes using different color and size of flock in the same design surface to be flocked. An adhesive is rendered tacky and each color of flock is passed through a screen that restricts that color to a desired part of the adhesive. A multicolor flock design is achieved on the surface.

The second method is known as flock transfers. Flock transfers consist of applying flock to a release sheet having a temporary adhesive coating. The flock is dyed with different color inks in a desired decorative design or pattern and coated with a binding layer and a hot melt adhesive. The transfer is then applied to an article, such as a garment, by using heat and pressure. Once the transfer is adhered to the article, the release sheet is peeled away from the flock leaving a finished decorative design.

Multicolor direct flocking and flock transfers suffer from several disadvantages. One disadvantage in direct flocking is it is an exacting procedure having many variables which need to be controlled. Further, the quality of the finished design, in particular, the sharpness of lines separating colors and the vivid images produced, is sometimes unacceptable. With respect to flock transfers, one disadvantage is that the printing ink used to form the desired design does not sufficiently penetrate the flock. Typically, the fibers used to form flock used in flock transfers are only 0.3 mm long. In direct flocking, colored flocks of 1 mm to 3 mm in length may be used.

Up until now, all plush flock transfers have been made with 1 mm, 3 denier fiber. If a four color process is used to print a design on the flock, a relatively fine line artwork resolution is required in order to achieve the illusion of creating an almost infinite number of colors with dots made with the four color process. For example, the four color printing process uses artwork which is photographed through a succession of color filters to produce four plates. Three of the plates are printed with color inks, such as cyan, yellow, and magenta. The fourth plate is printed with black ink. With a flock of 1 mm in length, the finest resolution which could be achieved is 25-line, 2400 d.p.i. using a 70 screen mesh (65% open area). However, this resolution is considered to be too rough and the image created appears to have a dot pattern instead of a smooth transition of color. In essence, it is very difficult to achieve the four color process illusion.

### SUMMARY OF THE INVENTION

In one form of the present invention, an enhanced resolution flock transfer comprises a release sheet having a surface coated with a release adhesive, flock having individual 0.75 millimeter 1.5 denier fibers, a design printed on the flock by use of a four color process by using side by side color separations, and a binding adhesive applied to the flock.

In another form of the present invention, a method of making an enhanced resolution flock transfer is disclosed. The method of making an enhanced resolution multicolored flock transfer comprises the steps of applying a coating of release adhesive on a release sheet, flocking the coating of release adhesive with flock having individual 0.75 millimeter 1.5 denier fibers, printing a design on the fibers by use of a four color process by using side by side color separations, and applying a binding adhesive to the flock.

In light of the foregoing comments, it will be recognized that a principal object of the present invention is to provide a flock transfer having improved resolution.

Another object of the present invention is to provide an enhanced flock transfer which is of simple construction and design and which can be easily employed with highly reliable results.

A further object of the present invention is to provide an enhanced flock transfer which has a smooth transition of color which achieves the four color process illusion.

A still further object of the present invention is to provide an enhanced resolution flock transfer which replaces screen printed designs.

These and other objects and advantages of the present invention will become apparent after considering the following detailed specification in conjunction with the accompanying drawings, wherein:

### BRIEF DESCRIPTION OF THE DRAWINGS

FIG. 1 is a cross-sectional view of a preferred embodiment of a enhanced resolution flock transfer constructed according to the present invention; and

FIG. 2 is a cross-section view of the enhanced resolution flock transfer shown in FIG. 1 that is applied to a substrate.

### DETAILED DESCRIPTION OF THE PREFERRED EMBODIMENTS

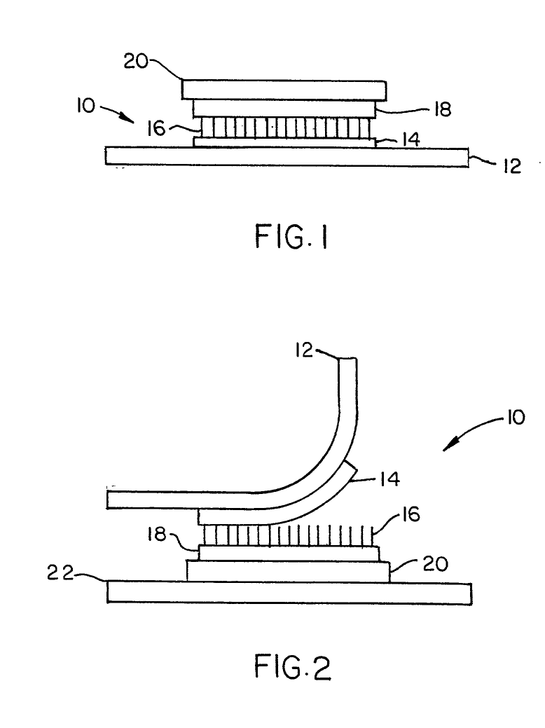

Referring now to the drawings, wherein like numbers refer to like items, number 10 identifies a preferred embodiment of an enhanced resolution flock transfer 10 constructed according to the present invention. With reference now to FIG. 1, the enhanced resolution flock transfer 10 is shown to comprise a release sheet 12 having a conventional flock transfer release adhesive 14, such as silicone wax, which is applied in the reverse of a desired pattern or design. The release sheet 12 may be paper or a transparent plastic material. The pattern corresponds to the overall image which is to be flocked. A flock 16, which may consists of rayon or any other type of conductive material such as nylon, polyester, etc., is applied to the adhesive 14 by conventional electrostatic methods or by use of gravity

The flock 16 is coated with a binder adhesive 18, such as a water based acrylic, which binds the flock into a unit. The binder adhesive 18 may also include another adhesive layer 20, such as a hot melt adhesive, which is used for binding or adhering the transfer 10 to a substrate (not shown), as will be explained. The hot melt adhesive layer 20 may consists of a granular polyester or rayon.

In order to achieve the enhanced resolution multicolor flock transfer 10, a finer, 0.75 millimeter long 1.5 denier fiber is used for the flock 16. With this thinner fiber, a 45-line@1200 d.p.i. artwork resolution may be used to print a pattern on the flock 16. A finer screen having 110 mesh that is capable of holding finer detail is used. The open area for the screen is only about 48%. The process color separations are changed in order to accommodate for some special requirements of the multicolor fiber coating process. In this process, the four color process illusion is achieved by creating side by side color separations instead of overlapping colors because when printing a solid fiber the colors cannot overlap. Further, with normal four color process color separations have natural voids created between the groups of color dots or rosettes. These must be eliminated or filled in with multicolor fiber coating in order to obtain the overall fiber density required for flock transfers. The gaps need to be filled to create a consistent fiber coating to support the subsequent layer of printed latex adhesive 20 or else it will fall down into the little gaps and ruin the fiber surface of the finished transfer 10.

With ink printing the gaps between color dots are naturally filled in with the white color of the paper background or substrate, printing on the flock 16 requires additional artwork to fill in these gaps. This additional artwork serves to fill in these areas with white fibers for visual purposes as well as to result in an even fiber coated surface to support the adhesive 20. In this manner, a true four color process transfer which is plush and has smooth color transition is achieved.

Referring now to FIG. 2, the transfer 10 is illustrated being applied or transferred to a substrate 22, such as a garment or other textile product. The hot melt layer 20 is placed against the substrate 22 and heat and pressure are applied to the release sheet 12. By applying heat and pressure to the release sheet 12, the hot melt layer 20 is able to bond the transfer 10 to the substrate 22. The release sheet 12 with the release adhesive 14 is then pulled away from and completely removed from the flock 16. The release sheet 12 is discarded and the transfer 10 is affixed to the substrate 22.

An example of a method of producing the transfer 10 comprises the following steps. A silicone wax layer, such as the release adhesive 14, is applied to the release sheet 12. Flock 16 is passed through a monofiliment polyester screen for a short duration of time, such as ten to fifteen seconds, through an electrostatic field. The flock 16 is embedded in the release adhesive 14 and allowed to dry. The flock 16 then has a pattern or design printed in reverse on the flock 16. The binder 18 then binds the flock 16 and is powdered with the hot melt adhesive 20. The transfer 10 is then allowed to dry. After brushing and vacuuming excess adhesive 20, the transfer 10 is placed in an infrared dryer to cross link the binder 18 and the adhesive 20. The transfer 10 then may be positioned on and applied to the substrate 22 by applying heat and pressure on the release sheet 12. The transfer 10 is allowed to cool and the release sheet 12, along with the release adhesive 14, are removed from the flock 16 to reveal or present the pattern. In this manner, the transfer 10 is affixed to the substrate 22.

From all that has been said, it will be clear that there has thus been shown and described herein an enhanced resolution multicolored flock transfer which fulfills the various objects and advantages sought therefor. It will become apparent to those skilled in the art, however, that many changes, modifications, variations, and other uses and applications of the subject enhanced resolution multicolored flock transfer are possible and contemplated. All changes, modifications, variations, and other uses and applications which do not depart from the spirit and scope of the invention are deemed to be covered by the invention, which is limited only by the claims which follow.

What is claimed is:

1. An enhanced resolution multicolored flock transfer comprises:
a release sheet having a surface coated with a release adhesive;
flock having individual 0.75 millimeter 1.5 denier fibers;
a design printed on the flock by use of a four color process by using side by side color separations; and
a binding adhesive applied to the flock.

2. The enhanced resolution multicolored flock transfer of claim 1 wherein the design comprises a 45-line at 1200 d.p.i. artwork.

3. The enhanced resolution multicolored flock transfer of claim 2 wherein the artwork further comprises additional artwork that fills in any gaps in the design.

4. The enhanced resolution multicolored flock transfer of claim 2 wherein the artwork is filled in with a multicolor fiber coating.

5. A method of making an enhanced resolution multicolored flock transfer comprising the steps of applying a coating of release adhesive on a release sheet, flocking the coating of release adhesive with flock having individual 0.75 millimeter 1.5 denier fibers, printing a design on the fibers by use of a four color process by using side by side color separations, and applying a binding adhesive to the flock.

6. The method of claim 5 wherein the design comprises a 45-line at 1200 d.p.i. artwork.

7. The method of claim 6 wherein the artwork further comprises additional artwork that fills in any gaps in the design.

8. The method of claim 6 wherein the artwork is filled in with a multicolor fiber coating.

9. The method of claim 5 further comprising the steps of positioning the adhesive on a substrate and applying heat and pressure to the release sheet to bind the transfer to the substrate.

10. The method of claim 9 wherein the substrate is a textile.

11. The method of claim 9 wherein the substrate is a garment.
